(19) United States
(12) Patent Application Publication
(10) Pub. No.: US 2025/0162278 A1
(43) Pub. Date: May 22, 2025

(54) PACKAGING MATERIAL AND PRODUCTION METHOD THEREOF

(71) Applicant: DURAN DOGAN BASIM VE AMBALAJ SANAYI A.S., Arnavutköy/Istanbul (TR)

(72) Inventors: Dikran Mihran ACEMYAN, Arnavutköy/Istanbul (TR); Dikran ACEMYAN, Arnavutköy/Istanbul (TR); Neslihan ÇAM AKDENIZ, Arnavutköy/Istanbul (TR); Levon KARABOSYAN, Arnavutköy/Istanbul (TR)

(21) Appl. No.: 18/838,979

(22) PCT Filed: Feb. 16, 2022
(86) PCT No.: PCT/TR2022/050138

§ 371 Date: Aug. 15, 2024

(51) Int. Cl. B32B 7/12; B32B 15/12; B32B 15/20; B32B 29/06; B32B 37/24; B32B 37/26; B32B 38/00; B65D 65/40; B65D 65/42

(52) U.S. Cl. CPC B32B 7/12; B32B 15/12; B32B 15/20; B32B 29/06; B32B 37/24; B32B 37/26; B32B 38/0004; B32B 38/0012; B32B 38/145; B65D 65/40; B65D 65/42; B32B 2037/243; B32B 2037/268; B32B 2255/12; B32B 2255/20; B32B 2255/26; B32B 2307/718; B32B 2307/7244; B32B 2307/7265; B32B 2307/7376; B32B 2317/18; B32B 2317/20; B32B 2329/04; B32B 2553/00

(57) ABSTRACT

The present invention relates to a paper-based packaging material which is an eco-friendly alternative to plastic packaging. The packaging material of the present invention that is recyclable and reusable but also providing the necessary oxygen. moisture, aroma and grease barrier features to keep the freshness of food for prolonged periods like in the case of packaging those made from the fossil sources or even superseding them.

### AIM OF THE INVENTION

This invention relates to paper-based packaging material, mainly dedicated for the food packaging, more specifically it relates to a high gas, water vapour, aroma and grease barrier paper-based packaging.

Today, increasing environmental awareness raises many concerns about the pollution of the nature and therefore, limiting the use of plastic materials has gained more importance than ever.

Because of that fact, the demand for the packagings of food and non-food products made of environmentally friendly materials has been increasing rapidly in order to replace those conventional ones that have been made of synthetic-based polymers such as polypropylene, polyethylene, polyethylene terephthalate, polyamide, or their combinations with each other and other polymers, all are manufactured from petroleum derivatives.

The aim of the present invention is the realization of an eco-friendly alternative to plastic packaging by producing paper-based packaging materials that are recyclable and reusable but also providing the necessary oxygen, moisture and grease barrier levels to keep the freshness of food for prolonged periods like in the case of packaging those made from the fossil sources or even superseding them.

### BACKGROUND OF THE INVENTION

Packaging used in the confectionery, biscuits and snacks categories usually consist of one or more plastic substrate(s).

In the present state of the art, although the most of the food packaging are made of plastic films and their combinations, there are also packaging where plastic packaging film and paper are used together in order to give a more natural look to the consumers, however packaging with such different structures are not preferable from the perspective of full recyclability and reusability due to the fact that they are composed of different materials from the natural and non-natural sources.

For example, in the state-of-the-art International Patent Application No WO2020/261170, gas barrier films based on micro fibrillated cellulose having a good and stable oxygen transmission rate at relatively high humidity levels have been mentioned. This state of the art document further relates to paper and paperboard-based packaging materials comprising such barrier films.

In the prior art, there are many metallised paper based packaging for which different techniques of metallisation have been used, mostly for decorative purposes in order to give the paper or cardboard more shiny and elegant look. For example labels and packaging of luxurious products like fragrances, spirits, etc., have partially or fully metallised surfaces in order to catch the attention of the consumers.

Metallisation is also used to make the paper and cardboard resistant against water, moisture, grease and mineral oils.

For all those packaging applications, there are several methods that the metallisation can be done on the base material.

The most widely used metallisation technique is the lamination of the paper with the thick aluminium foil having thickness usually above 5 microns. Here the metallic foil sticks to the paper or board by means of a glue or an extruded hot polymer melt. This technique has been used for making industrial bags, sacks and for the pouches of various food, for example for the cereals, coffee, powdery products, medical packaging, tobacco packaging, etc., since years.

Another metallisation technique is the conventional vacuum deposition technique where the metal (usually it is aluminium) is melted in a vacuum chamber, evaporated and the evaporated metal molecules are deposited on the web passing around a chilled roll, then the final product gains metallic finish. Thickness of the metal layer is usually kept in the range of 500-900 angstroms.

For many labelling applications, food packaging and tobacco packaging this technique have been used either for the decorative purposes or to give moisture barrier in order to protect the contents against the ambient humidity or to keep the moisture of the contents inside the pack to preserve their freshness for a prolonged time.

Another technique of metallisation is based on the physical vacuum deposition (PVD) or chemical vacuum deposition (CVD) methods where the metal oxides like AlOₓ (for example Al₂O₃), SiOₓ (for example SiO₂) and their combinations either in the mixture form or in the form of separate layers one over each other are coated to give a very thin, transparent inorganic film forming.

This technique have been used for the packaging of moisture and oxygen sensitive food since years, mainly on the polyester films and in lesser extent on paper-based packaging.

### DETAILS OF THE PRESENT INVENTION

The packaging material realized to attain the aim of the present invention, explicated in the first claim and the respective claims thereof, comprises a main base which is paper, a thin metal layer, preferably from aluminium, coated on the base by transfer metallisation method and glue between the main base and the metal layer. In the preferred embodiment the packaging material further comprises at least one functional coating that is further added under or onto this transfer metallised surface to reach the targeted barrier levels for keeping the contents in the packaging fresh.

As a result of the use of the transfer metallisation method primarily high oxygen, water vapour barrier paper based substrates have been created which also give grease, aroma and mineral oil barrier.

The transfer metallisation method used in the invention comprises the following steps:
Coating the main base with a metal layer which is on a carrier film wherein the coating is accomplished by glue, preferably of acrylic nature,
Peeling off the carrier film, leaving the metal layer on the main base.

As a result, a roll of paper or cardboard with a thin metallic layer is obtained by transferring the metal, preferably aluminium from a polymeric film.

In the preferred embodiment of the invention the carrier film is preferably at least 350 angstroms thick.

In the preferred embodiment of the invention the peeled off transparent carrier is later recycled in PET stream which is another eco-friendly aspect of the invention.

In alternative embodiments of the invention the packaging material roll can be further treated with a slitting step or used as a roll depending on the subsequent converting process.

Following the appropriate converting processes including the artwork printing, brand logo, etc., or labelling applications, metallised paper/cardboard is fed to the dedicated packaging lines to be given a form in order to cover, protect and carry the contents safely.

In the last step, packs are sealed either by exerting heat, by hot or cold glue or ultrasonic sealing or made ready for transit and displayable to the consumers at the point of sales.

Generally metallised substrates are preferred to give moisture barrier for the food packaging.

The main objective of the present invention is to make a high oxygen, aroma and water vapour barrier packaging substrate that comprises transfer metallised layer by combining it with various functional coatings.

The drawings are not meant to delimit the scope of protection as identified in the claims nor should they be referred to alone in an effort to interpret the scope identified in the claims without recourse to the technical disclosure in the description of the present invention.

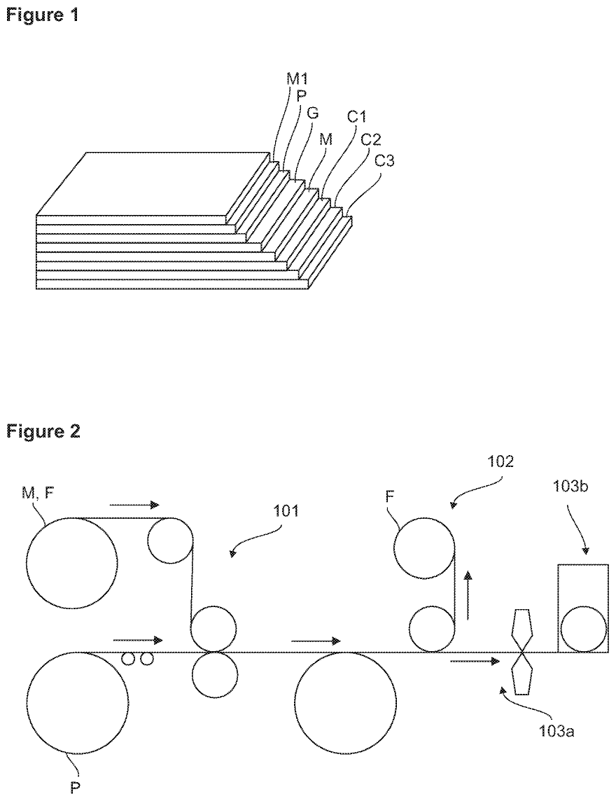

FIG. 1—Schematic view of the packaging material of the present invention

FIG. 2—Schematic view of the transfer metallization process

The following designation are assigned to different layers of the packaging demonstrated in the drawings and referred in the present detailed description of the invention:
M1: Outer metal layer
P: Main base
G: Glue
M: Metal layer
C1: Pre-coat layer
C2: Barrier layer
C3: Protective layer
F: Carrier film

The packaging material comprises a fibre-based main base (P) preferably paper or cardboard having a metal layer (M), preferably an aluminium layer, which is transferred onto the inner side of the main base (P) by peeling it from a carrier film (F) of polymeric origin.

In an embodiment of the present invention the packaging material the metal layer (M) is fixed on the main base (P) with glue (G) to assure the adhesion.

The main base (P) functions as a receptive media for all the chemicals and the coatings that will be further applied on its one side or both sides.

The main base (P) can be any kind of paper. In the preferred embodiment of the invention main base (P) is a white paper having at least;
min 40 gr/m² grammage,
min 40 microns thickness
max 5% moisture content

where at least one side is calendered and/or chemically pre-treated. In the preferred embodiment such pre-treatment is clay coating done at the mill in order to maximise the closure of the micro holes and the cracks that may otherwise adversely affect the barrier properties during the subsequent coating processes and at later stages like conversion.

Main base (P) doesn't comprise flouro chemicals, PVDC or any hazardous materials and ozone depleting chemicals

The glue (G) sticks the metal layer (M) to the main base (P). Glue (G) can be any type of solventless, solvent based, water based or UV curable adhesive that has strong adherence to the metal layer (M) and the main base (P).

Chemically glue (G) can be from the families of urethanes, latexes, polyesters, vinyl acetates, modified ethylene copolymers of vinyl alcohol, acrylics or saccharides, for example;
the mixtures of 5-chloro-2-methyl-4-isothiazolin-3-one [EC No 247-500-7] and 2-methyl-4-isothiazolin-3-one [EC No 220-239-6] (3:1);
copolymers of styrene and butadiene latex;
EVA (Ethylene Vinyl Acetate) co and terpolymers, preferably water dissolvable but can also be with solvent-based carriers;
Copolymers of ethylene and unsaturated carboxylic acids or their ester compounds in a water-based systems like; EAA (Ethylene Acrylic Acid copolymer), EMAA (Ethylene Methacrylic Acid copolymer), EMA (Ethylene Methyl Acrylate copolymer), EEA (Ethylene Ethyl Acrylate copolymer), EMMA (Ethyl Methyl Methacrylate copolymer) which also help to improve barriers against grease, oil and moisture;
Aqueous solutions of polysaccharides with the generic formula of (C₆H₁₀O₅) n based on cellulose, starch, glycogen or chitin.

Glue (G) can be applied on the metal layer (M) by means of several coating methods like rod, reverse roll, air-knife, flexography or rotogravure.

The metal layer (M) which is transferred from a polymeric carrier film (F) on to the main base (P) and is preferably made of aluminium has in the preferred embodiment the following properties:
at least 99,9% purity
at least 100 Angstroms thickness
(average) 2-3 optical density

In the preferred embodiment of the invention, main function of the metal layer (M) is to provide moisture barrier which is crucial to keep the freshness and crispiness of the many dry foods.

In an embodiment of the invention the transferred metal layer (M) is preferably made of vacuum deposited thin, non-transparent aluminium oxide coating.

Furthermore, the metal layer (M) can also be made of inorganic transparent coating of aluminium or silicone or their oxides like SiO₂, Al₂O₃ or their mixtures made by either of physical vapour deposition or chemical vapour deposition techniques. Alternatively, metal oxides of magnesium, zinc or copper can also be used to improve the said barrier properties.

The pre-coat layer (C1) is water resistant and preferably is selected from the family of EVA (Ethylene Vinyl Acetate) co and terpolymers, EAA (Ethylene Acrylic Acid) polymers, Styrene acrylate and PEI (Polyethyleneimine), for example;
EVA (Ethylene Vinyl Acetate) co and terpolymers, preferably water dissolvable but can also be with solvent-based carriers.
Copolymers of ethylene and unsaturated carboxylic acids or their ester compounds in a water-based systems like EAA (Ethylene Acrylic Acid copolymer), EMAA (Ethylene Methacrylic Acid copolymer), EMA (Ethylene Methyl Acrylate copolymer), EEA (Ethylene Ethyl Acrylate copolymer), EMMA (Ethyl Methyl Methacrylate copolymer) which also helps to improve barriers against grease, oil and moisture
Styrene acrylate dispersions in water.
PEI (Polyethyleneimine)

In one embodiment of the invention, the packaging material further comprises a oxygen barrier layer (C2) that acts as a barrier against oxygen.

In this embodiment the oxygen barrier layer (C2) is coated onto the pre-coat layer (C1). In this embodiment the pre-coat layer (C1) strengthens the bonding of the oxygen barrier layer (C2) onto the metal layer (M).

The oxygen barrier layer (C2) also protects the metal layer (M) against scratches and micro holes.

In one embodiment, the oxygen barrier layer (C2) is an ethylene modified vinyl alcohol (PVOH) copolymer, more specifically water soluble EVOH which is a non-ionic, water soluble polymer giving excellent barrier properties against oxygen, grease, aroma, oil and mineral oils. Since it is also recyclable and repulpable, PVOH has been chosen as a sustainable material that might be easily processed together with paper-based wastes.

In its water dissolvable form, the oxygen barrier layer (C2) of this embodiment also provides strong anchorage with the paper based metallised and non-metallised substrates, besides it gives very good, shiny and uniform film forming on the surface of the suitable pre-treated paper and transferred metal coatings. It also exhibits good printability characteristics.

During the coating trials it has been shown that the non-PVOH coated metallised paper gives oxygen transmission rates above 10 cc.m²/day under ambient conditions, i.e.; 23C, 50% RH (measurements has been done from the metal side).

On the other hand, it has been seen that when the suitably selected paper is metallised and then coated with 10-15% (w/w) solution of PVOH in water as the oxygen barrier layer (C2), this structure gives oxygen barrier levels less than 1.0 cc.m²/day at 23C, 65% RH, if the coating thickness is kept around 5.0 mics. The higher coating thicknesses obviously gives lower oxygen transmission rates.

More specifically, it has been proved that 12% modified PVOH dissolved in water gives oxygen barrier levels as low as 0.1 cc.m²/day (at 23° C., 50% RH) with 12.5 gr/m² wet coating weight (that makes 1.5gr/m² equals approx. 1.5 mics thick dry weight) and it is clear that PVOH coated paper packaging material has significantly improved oxygen barrier over its non-coated version.

In another embodiment of the present invention, the oxygen barrier layer (C2) which is used to improve the oxygen barrier level is the water based solution of saccharides that is coatable on the metal layer.

With the water based emulsion of saccharides having 30% solid content and approx. 4-5 gr/m² dry weight coating on the metallised paper, oxygen barrier levels as low as 0.4 cc/m².d have been achieved under the ambient conditions.

In a different embodiment the packaging material may have only the oxygen barrier layer (C2), but not the pre-coat layer (C1). In this embodiment the metal layer (M) is fixed by transfer metallisation process at least to one side of the main base is directly coated without any pre-coat layer (C1).

In another version of this embodiment the oxygen barrier layer (C2) is made of polysaccharides, more specifically by starch or cellulose or both, in order to give the packaging material gas, aroma, oil and grease barrier.

In another embodiment of the present invention the packaging material further comprises a protective layer (C3) coated on the main base (P) on top of the barrier layer (C2) in order to prevent the barrier layer (C2) to be affected from the ambient moisture which may deteriorate its oxygen barrier but at the same time depending on the final packaging application it can also exhibit heat sealability feature.

In the preferred embodiment of the invention the protective layer (C3) is water soluble, preferably a compostable water soluble emulsion or dispersion and accordingly is water resistant.

In an embodiment of the invention the protective layer (C3) is cold seal gluable and acts as a receptive layer for the latex based cold seal glues. In an embodiment of the invention the protective layer (C3) is water based, solvent free or solvent based and can be non-sealable or sealable.

Protective layer (C3) can be from any type of acrylic polymers, preferably from EVA (Ethylene Acetate), EAA (Ethylene Acrylic Acid) polymers, Vinyl polymers, Polyesters and ionomers.

In different embodiments of the invention the protective layer (C3) is based on;
EVA (Ethylene Vinyl Acetate) co and terpolymers, preferably water dissolvable but can also be with solvent-based carriers.
Copolymers of ethylene and unsaturated carboxylic acids or their ester compounds in a water-based systems like EAA (Ethylene Acrylic Acid copolymer), EMAA (Ethylene Methacrylic Acid copolymer), EMA (Ethylene Methyl Acrylate copolymer), EEA (Ethylene Ethyl Acrylate copolymer), EMMA (Ethyl Methyl Methacrylate copolymer) which also helps to improve barriers against grease, oil and moisture
Steyrene acrylate dispersions in water.

In another embodiment of the present invention, the packaging material comprises on other side of the main base (P) also an outer metal layer (M1) formed preferably by transfer metallization method, mainly for the aesthetics and metallic look.

In this embodiment the same transfer metallisation process that has been applied to the inner side of the main base (P) is applied to the outer metal layer (M1) side as well.

The outer metal layer (M1) can be partially or fully printed depending on the artwork of the brand owner, either directly or after priming.

The carrier film (F) for the metal layers (M) and (M1) can be any polymeric film either in the form of oriented or non-oriented, preferably from those where the backbone polymer can be from the family of polyolefins, polyethylene terephthalate or polyamide.

Thus, an environmentally friendly packaging material is obtained instead of packaging materials made of synthetic-based polymers such as polypropylene, polyethylene, polyethylene terephthalate, polyamide, which are made of petroleum derivatives. In addition, an effective moisture and oxygen barrier is achieved, providing both food protection and an alternative, environmentally friendly packaging material to packaging of plastic origin.

The metal layer (M) is fixed at least to one side of the main base, predominantly improves the MVTR (Moisture Vapour Transmission Rate) giving the following values for both MVTR and OTR (Oxygen Transmission Rate).

MVTR: <2.0 g/m².d (23° C., 85% RH)

MVTR: <1.0 g/m².d (23° C., 50% RH)

MVTR: <10.0 g/m².d (38° C., 90% RH)

OTR: <50 ccm/m².d (23° C., 50% RH)

In the preferred embodiment of the packaging material that is metallised paper exhibits the following barrier properties after it is coated with layer (C2) which is made of either PVOH or saccharides:

MVTR: <1,6 g/m².d (23° C., 85% RH)

MVTR: <1.0 g/m².d (23° C., 50% RH)

OTR: <0.5 ccm/m².d (23° C., 50% RH)

The method of manufacturing of packaging material of the present invention comprises the following steps:
Coating the main base (P) with a metal layer (M), which is on a carrier film (F) wherein the coating is accomplished by glue (G), preferably of acrylic nature (101);
Peeling off the carrier film (F), leaving the metal layer (M) on the main base (P) (102).

In an embodiment of the invention the manufacturing method comprises the further step of treating the packaging material with a slitting step (103a) after the step (102).

In another embodiment of the invention the manufacturing method comprises the further winding step (103b) of the packaging material after the step (102).

In an embodiment of the invention the manufacturing method comprises the further step of converting the packaging material including the artwork printing, brand logo, etc., or labelling applications after the step (103a or 103b).

1.-23. (canceled)

24. The packaging material comprising
a fibre based main base (P), preferably a paper or a cardboard that is free of flouro chemicals and PVDC and having min 40 gr/m² grammage,
a metal layer (M) and
glue (G) between the main base (P) and the metal layer (M) to assure the adhesion
wherein the metal layer (M) is transferred onto the inner side of the main base (P) by peeling off from a carrier film (F) of polymeric origin and said metal layer (M) has a thickness of 100-900 angstroms and is made of non-transparent inorganic coating of aluminium, magnesium or copper or inorganic transparent coating of aluminium, magnesium, copper or silicone or their oxides like SiO₂, Al₂O₃ or their mixtures made by either of the physical vapour deposition (PVD) or chemical vapour deposition (CVD) methods.

25. The packaging material according to claim 24, wherein the main base (P) is a white paper having at least;
min 40 microns thickness
max 5% moisture content
where at least one side is calendared and/or chemically pre-treated.

26. The packaging material according to claim 25, wherein one side is pre-treated by clay coating at the mill.

27. The packaging material according to claim 24, wherein the metal layer (M) is of aluminium with a thickness of at least 100 angstroms.

28. The packaging material according to claim 25, wherein the glue (G) is selected from the families of urethanes, latexes, polyesters, vinyl acetates, modified ethylene copolymers of vinyl alcohol, acrylics or saccharides.

29. The packaging material according to claim 24, wherein the metal layer (M) has
at least 99.9% purity,
at least 100 Angstroms thickness,
(average) 2-3 optical density.

30. The packaging material according to claim 24, wherein the metal layer (M) is made of magnesium or copper.

31. The packaging material according to claim 24, wherein the metal layer (M) is made of inorganic transparent coating of aluminium, silicone or their oxides like SiO₂, Al₂O₃ or their mixtures by either of the physical vapour decomposition (PVD) or chemical vapour decomposition (CVD) methods.

32. The packaging material according to claim 24, wherein the packaging material further comprises a barrier layer (C2) that functions as a barrier against oxygen, aroma, grease and mineral oil and a pre-coat layer (C1) that strengthens the bonding of the oxygen barrier layer (C2) onto the metal layer (M).

33. The packaging material according to claim 32, wherein the pre-coat layer (C1) is water resistant and is selected from the family of EVA (Ethylene Vinyl Acetate) co and terpolymers, EAA (Ethylene Acrylic Acid) polymers, Styrene acrylate and PEI (Polyethyleneimine).

34. The packaging material according to claim 32, wherein the oxygen barrier layer (C2) is an ethylene vinyl alcohol (PVOH) copolymer which is a non-ionic, water soluble polymer.

35. The packaging material according to claim 33, wherein the oxygen barrier layer (C2) is made of polysaccharides more specifically by starch or cellulose or both.

36. The packaging material according to claim 24, comprising a protective layer (C3) coated on the main base (P) on top of the barrier layer (C2) in order to prevent the barrier layer (C2) to be affected from the ambient moisture.

37. The packaging material according to claim 36, wherein the protective layer (C3) is water soluble, preferably a compostable water soluble emulsion or dispersion.

38. The packaging material according to claim 36, wherein the protective layer (C3) is selected from any type of acrylic polymers, preferably from EVA (Ethylene Acetate), EAA (Ethylene Acrylic Acid) polymers, Vinyl polymers, Polyesters and ionomers).

39. The packaging material according to claim 36, wherein the protective layer (C3) is cold seal gluable and acts as a receptive layer for the latex based cold seal glues.

40. The packaging material according to claim 24, on the other side of the main base (P) also an outer metal layer (M1) formed preferably by transfer metallization method.

41. The method of manufacturing of the packaging material according to claim 24, comprising the following steps:
Coating the main base with a metal layer (M) which is on a carrier film (F) wherein the coating is accomplished by glue (G), preferably of acrylic nature (101);
Peeling off the carrier film (F), leaving the metal layer on the main base (P) (102).

42. The method of manufacturing of the packaging material according to claim 41, comprising the further step of treating the packaging material with a slitting step (103a) after the step (102).

43. The method of manufacturing of the packaging material according to claim 41, comprising the further winding step (103b) of the packaging material after the step (102).

44. The method of manufacturing of the packaging material according to claim 41, comprising the further step of converting the packaging material including the artwork printing, brand logo, etc., or labelling applications after the step (103a or 103b).
